(19) United States
(12) Patent Application Publication
(10) Pub. No.: US 2009/0198815 A1
(43) Pub. Date: Aug. 6, 2009

(54) Criteria-based creation of organizational hierarchies in a group-centric network

(76) Inventor: Nelson Nicola Saba, Orlando, FL (US)

Correspondence Address: CARR & FERRELL LLP, 2200 GENG ROAD, PALO ALTO, CA, 94303, US

(21) Appl. No.: 12/012,797

(22) Filed: Feb. 4, 2008

(51) Int. Cl. G06F 15/173

(52) U.S. Cl. 709/225

(57) ABSTRACT

Exemplary systems and method for creating organizational hierarchies in a group-centric network are provided. In exemplary embodiments, a request from a user to establish a new group within the organization on the group-centric network is received by the group-centric network host. The group-centric network host retrieves an applicable, predetermined set of criteria for group creation, and determines if terms in the request match the predetermined set of criteria. If there is a match, the new group is created and one or more relationships of the new group may be activated.

### CROSS-REFERENCE TO RELATED APPLICATIONS

The present application claims benefit of U.S. Provisional Patent Application No. 60/899,092 filed Feb. 2, 2007, and entitled “Group-Centric Social Network,” which is hereby incorporated by reference. The present application is also related to co-pending U.S. patent application Ser. No. 11/728,218 filed Mar. 23, 2007, and entitled “Creation of Organizational Hierarchies in a Social Network via Handshake Mechanisms,” which is also hereby incorporated by reference.

### BACKGROUND

1. Field of the Invention

Embodiments of the present invention are directed to networking and more particularly to creation of organizational hierarchies in a network.

2. Related Art

Presently, users may utilize social networks to communicate with others socially. These social networks are typically a collection of individuals accessing a single social network host, and typically represent both a collection of ties between people and strength of those ties. In some embodiments, the social network is a map of relationships between individuals, which indicates ways in which individuals are connected through various social familiarities ranging from casual acquaintance to close familial bonds, for example.

Typically, each individual within the social network has their own web page on which any information the individual desires to present may be posted. Some information on the web page may be private, such that only those with relationships with the individual can view the private information. Other information may be public, such that any member of the social network may be able to view the public information.

Often times, the relationships are created between two individuals via an invitation from one individual to the other. In some embodiments, a request to establish a relationship may also be utilized to create the relationship.

Networks of generic organizations may also be present on the Internet. However, there are no networks which allow these organizations to be represented as a hierarchical organization of groups. Furthermore, these is no network which allow the establishment of these hierarchical organizations via predetermined sets of criteria.

### SUMMARY OF THE INVENTION

Embodiments of the present invention provide systems and methods for creating organizational hierarchies in a group-centric network based on a predetermined set of criteria. In exemplary embodiments, a request from a user to establish a new group within an organization on the group-centric network is received by the group-centric network host. The request may comprise a plurality of terms.

The group-centric network host retrieves an applicable, predetermined set of criteria for group creation. The applicable set of criteria may be chosen based on the contents of the request including the organization and requested parent group(s).

A determination is made as to whether all terms in the request match the predetermined set of criteria. If there is a match, the new group is created and one or more relationships of the new group may be automatically activated. In some embodiments, some relationships may not be activated until a message-based handshake is performed between the new group and established groups with which the relationship is desired.

If there is no match, the group creation may be denied or preliminarily denied. In some embodiments, message-based handshakes may be performed between the user and an authorized individual when there is no match. The message-based handshakes may comprise request and responses for suggestions or further information. The authorized individual may also override a preliminary denial.

### BRIEF DESCRIPTION OF THE DRAWINGS

FIG. 1 is a block diagram of an environment in which embodiments of the present invention may be practiced.

FIG. 2 is a block diagram of an exemplary hierarchical structure within one organization of the social network.

FIG. 3 is a block diagram of an exemplary social network host.

FIG. 4 is a block diagram of an exemplary accounts engine.

FIG. 5 is a block diagram of an exemplary messaging engine.

FIG. 6 is a flowchart of an exemplary method for establishing a child group within an organization on the group-centric network.

FIG. 7 is a flowchart of an exemplary method for attempting to establish a child group after an initial denial.

FIG. 8 is a flowchart of an exemplary method for establishing a child group involving an override.

### DETAILED DESCRIPTION OF EXEMPLARY EMBODIMENTS

Embodiments of the present invention provide systems and methods for creating and maintaining organizational hierarchies in a group-centric network. In exemplary embodiments, the organizational hierarchy and one or more predetermined set of criteria for establishing groups within the organizational hierarchy may be determined by leaders or other authorized individuals within the organization. When a user requests creation of a group within the organization that satisfies a predetermined set of criteria, then the group is allowed to be created. In some embodiments, the group creation may occur without any action by the leaders. In other embodiments, the leaders may still have authority to deny group creation.

In various embodiments, the group-centric social network allows organizations to be represented and made functional over a network, such as the Internet. Groups, projects, and services of each organization may then be connected through managerial, functional, and business relationships, established within and according to an organizational structure. According to some embodiments, the group-centric network may comprise a group-centric social network. In alternative embodiments, the group-centric network may comprise a group-centric enterprise, business, or educational network, or any other type or combination of types of networks.

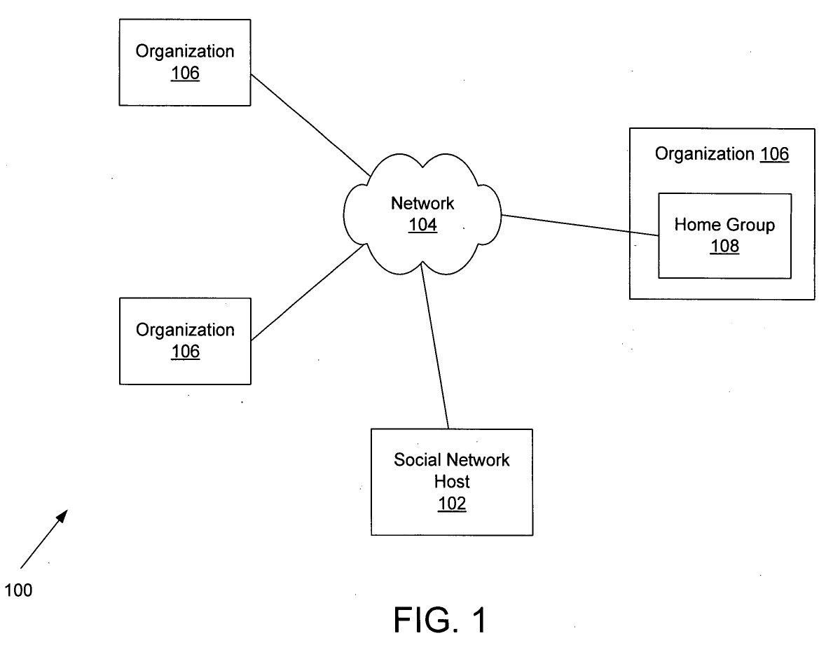

Referring now to FIG. 1 an exemplary environment 100 in which embodiments of the present invention may be practiced is provided. The exemplary environment 100 comprises a group-centric network host 102 coupled via a communications network 104 to a plurality of organizations 106. The communications network 104 may comprise any type of communications network, such as the Internet.

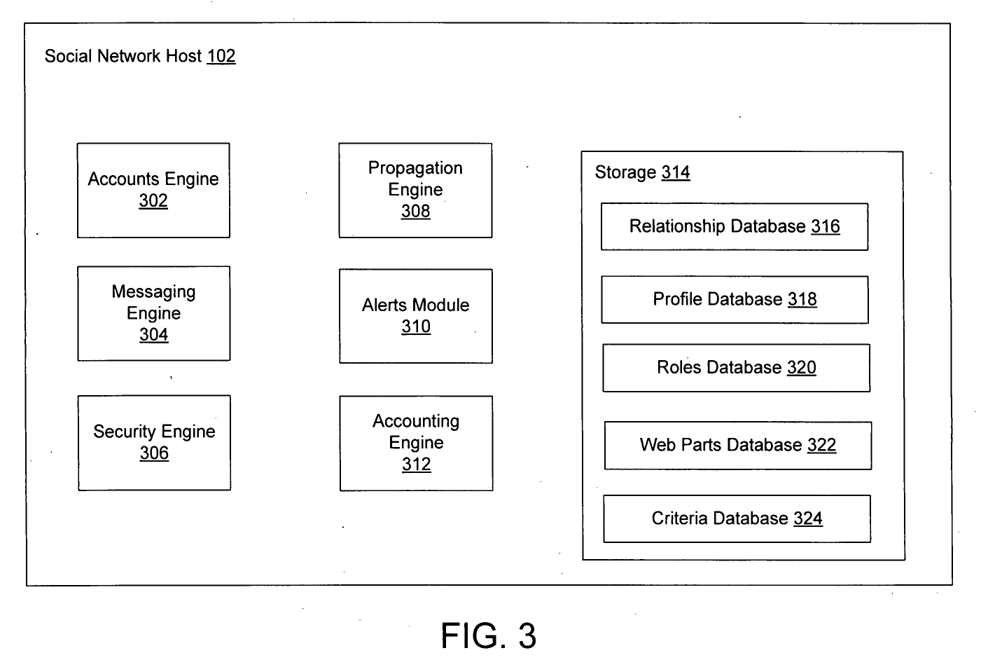

In exemplary embodiments, the group-centric network host 102 comprises one or more servers configured to create and maintain the group-centric network of organizations 106 and groups within the organizations 106 using various mechanisms to establish groups and their relationships. The group-centric network host 102 will be discussed in more details in connection with FIG. 3 below.

The organization 106 represents any entity that desires to establish a presence on the group-centric network. The organization 106 may comprise profit or nonprofit entities. For simplicity of discussion, examples of the present invention will be discussed utilizing churches as the organizations 106. However, the organizations 106 may comprise any type of organizations, such as businesses, franchises, sponsors, universities, retail chains, advertisers, and partners. The sponsors or partners may be organizations 106 which provide goods or services to other organizations 106 on the group-centric network.

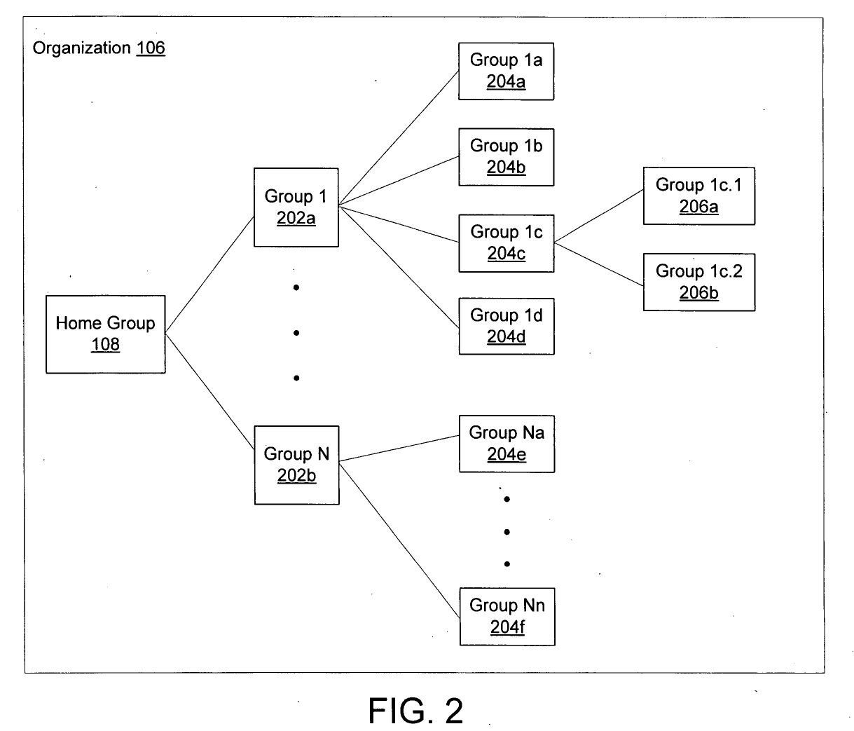

In exemplary embodiments, each organization 106, at a highest level, is represented on the group-centric network as a home group 108. The home group 108 is a highest level group in an organizational structure that may be established for the organization 106. Each home group 108, in turn, may be linked to one or more subgroups. These subgroups are termed “child groups” of the home group 108 as they are spawns off of the home group 108 or “parent group.” An example of this organizational structure will be discussed in more details connection with FIG. 2.

FIG. 1 illustrates one exemplary embodiment of the environment 100 in which embodiments of the present invention may be practiced. Alternative embodiments may comprise any number and types of organizations 106 coupled to any type of communications network 104. Additionally, more than one group-centric network host 102 may be present.

Referring now to FIG. 2, an exemplary organizational structure for the organization 106 is shown. The overall organization 106 is represented on the group-centric network as the home group 108. The home group 108 may comprises (e.g., be linked to) one or more child groups. In FIG. 2, the home group 108 is shown directly coupled to a plurality of child groups (e.g., group 1 202a through group N 202b). Any number of these first level child groups 202 may be coupled to the home group 108. For example, if the home group represents Wood River Church on the group-centric network, then child group 1 202a may represent Small Groups Ministry of the Wood River Church.

Furthermore, each first level child group 202 may be coupled to one or more second level child groups. As shown, child group 1 202a comprises a plurality of second level child groups (e.g., group 1a 204a through group 1d 204d). Similarly, child group N 202b is coupled to a plurality of second level child groups (e.g., group Na 204e through group Nn 204f). Any number of second level child groups 204 may be established and coupled to the first level child group 202. As a result, the first level child group 202 becomes a parent to the second level child group 204. Alternatively, the first level child group 202 may not be coupled to any second level child groups 204.

Continuing with the example, the Small Groups Ministry may comprise a plurality of small ministry groups, each small ministry group comprising at least one leader and one or more members. These small ministry groups may be referred to as child groups of the Small Group Ministry, which is a parent to the small ministry group.

As further shown, the second level child group 204, itself, may be a parent to third level child groups 206. The organizational structure allows any number of levels of child groups to be established within the single organization 106. Additionally, any number of parent-child relationships may be established within the organizational structure represented on the network 104 with any specific child group having one direct parent.

Each group within the organization 106 (e.g., home group 108, child groups 202-206) may be defined by its profiles, functions, relationships, and members. The group profile comprises basic group information which is provided upon group creation. The group information may include, for example, characteristics, purpose, identification of a group leader, and contact information for the group leader.

The group profiles may also comprise security settings for the groups as well as for each user in the group-centric network. According to one embodiment, the group profile may comprise general security settings for all data associated with the group. For example, only logged in group members may be allowed to access data on the group's web page. Alternatively, the group profile may set default security settings for each component on a web page created for the group. In this embodiment, the components may comprise different security settings such that some may be accessed only by group members, and other data, for example, may be accessed by the public.

Each organization 106 may be represented on the network 104 as an organizational structure comprising groups 108 and 202-206 networked together through various relationships. These relationships establish how each group 108, 202, 204, or 206 is coupled within the organizational structure to other groups 108 and 202-206 and individual users. Exemplary relationships may comprise line relationships, lateral relationships, staff relationships, functional relationships, group membership relationships, and individual membership relationships. The line relationship comprises a direct parent-child relationship between two groups 108, 202, 204, or 206 in the organizational structure. For example, there is a parent-child relationship between the home group 108 and first level child group 1 202a.

The lateral relationship comprises a relationship between groups on the same hierarchical level. In the example of FIG. 2, there is a lateral relationship between child group 1 202a and child group N 202b.

The staff relationship comprises a relationship between, for example, an administrative group and other groups 108, 202, 204, or 206 for advisory purposes. For instance, an information technology group may form relationships with a plurality of child groups 202-206 in order to provide technical assistance. A user that is a member of the administrative group may have security settings that allow the user to access certain sections of the web pages of the groups 108, 202, 204, or 206 the administrative group administers. For example, the administrative group member may have associated security settings that allow the member to access and change data on the group web page.

The functional relationship may comprise a relationship between a special purpose group and other groups 108, 202, 204, or 206. In some embodiments, this relationship comprises a line relationship that relates to the special function of the group. These groups may have a special purpose and, therefore, a limited set of functions the group can perform, which will be reflected in an actual set of web parts available for the group. In one embodiment, the relationship of the special purpose group (e.g., church store) may allow a member of the special purpose group to access and change data on a web page of another group. For example, a member of the church store may access and edit advertisement for the church store on a group's web page.

The group membership relationship comprises a relationship that establishes that a group belongs to an organizational structure. This relationship is, in some embodiments, established with the home group 108 of the organization 106. In other embodiments, membership may be between two independent organizations 106 (each one with its own home group 108), wherein one organization 106 is a member of the other organization 106. An example of this comprises a church denomination and its churches. Both are organization 106 having independent group hierarchies with their own home groups 108. However, there is a membership relationship between the home group 108 of each church (e.g., organization 106) of that denomination and an organization 106 of the church denomination hierarchy. A specific example comprises the Orlando Church of the Nazerne, which is a member of the Nazarene Denomination through a relationship of the Orlando Nazarene Church home group with the group “South East Region” of the Nazarene Denomination hierarchy.

The individual membership relationship comprises relationships established between an individual and the group 108, 202, 204, or 206 making that individual a member of that group 108, 202, 204, or 206. Members comprise individuals that participate in the group 108, 202, 204, or 206 in different roles. The roles may comprise leaders, project managers, general members, and so forth.

Furthermore, there may be two types of relationships: within the organization 106 and outside of the organization 106. Within the organization, there are relationships between groups 108 and 202-206 (e.g., parent and child) and individual relationships (e.g., member, leaders). Outside of the organization 106, relationships may be established between different organizations 106 (e.g., sponsorship, partnership, etc.). In exemplary embodiments, the establishment of relationships may be based on the predetermined set of criteria. For example, if a user establishes a child group that fits a predetermined set of criteria for a home group, a relationship may be activated between the home group and the child group.

Once created, each child group 202-206, as well as the home group 108, may be represented on the network 104 by one or more group web pages. These web pages may reflect the group's profile, functions, relationships, leadership, and members. As such, the web pages may be customized by each group 108 and 202-206.

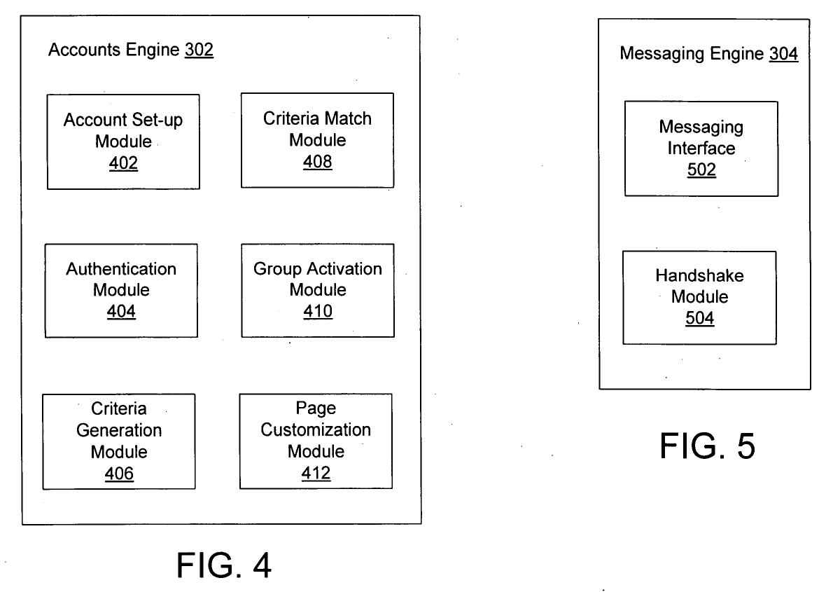

Referring now to FIG. 3, the group-centric host 102 is shown in more detail. In exemplary embodiments, the group-centric host 102 comprises an accounts engine 302, a messaging engine 304, a security engine 306, a propagation engine 308, an alerts module 310, an accounting engine 312, and storage 314. The exemplary accounts engine 312 is configured to create and manage individuals, groups, and organizations 106 on the network 104 as well as relationships between these entities. The accounts engine 312 will be discussed in more detail in connection with FIG. 4.

The exemplary messaging engine 304 is configured to provide mechanisms to communicate within the network 104 including providing handshake or messaging mechanisms. These handshake mechanisms may be used to establish, confirm, and/or deny activation of relationships between groups 104 and 202-206. The messaging engine 304 will, in exemplary embodiments, generate and forward messages (e.g., e-mails) between individuals (e.g., group leaders, administrative staff, users, etc.). The messaging engine 304 will be discussed in more detail in connection with FIG. 5.

In exemplary embodiments, the security engine 306 limits access and functions within the organization 106 based on roles and relationships of groups 108 and 202-206 and individuals with regards to the organization 106. For example, some data posed on a group's web page may be made private. This private data may only be accessed by, for example, group leaders. In some embodiments, the access for each piece of data may be set in a profile for the data which is established when the data is first posted to the web page. In some embodiments, there may be three levels of access: public (e.g., anyone can view), members (e.g., must be a member to view), and leaders (e.g., only leaders can view). Alternative embodiments, may comprise other levels of access or combinations of levels of access. The security engine 306 will determine based on the levels of access whether an individual accessing the data is permitted to view the data.

In some embodiments, the security engine 306 may restrict an individual's functions based on their role in the organization 106. For example, functions related to a group's web pages may be limited based on privacy settings. The privacy settings may comprise leaders, members, administrator, and public. Thus for instance, a general member of a group may not be permitted to change the group's page, but only allowed to view the contents. Data on individual web pages may also apply privacy settings.

The security engine 306 may also restrict an individual's ability to establish a child group. For example, a general member that is new to the organization may not be allowed to create a new child group.

The exemplary propagation engine 308 is configured to propagate data within the organization 106. For example, if a child group has a posting of new events, the new events may be propagated up to the parent group of this child group. As a result, a page of the parent group may show the new event on their events calendar. In some embodiments, propagation of data occurs if a profile of the data allows for it. For example, if the data is specific only to a particular group, then the data may not be allowed to propagate the data up to the next level (e.g., the parent group). In some embodiments, data may be propagated down as well (e.g., from a parent group to child groups) and displayed on the child group pages.

In exemplary embodiments, the alerts module 310 is configured to provide alerts to an individual based on settings set by the individual, for example, in their profile. As such, the alerts module 310 monitors data within the organization 106 to determine if new data has been posted. If new data is posted, the alerts module 310 determines if any individuals have requested an alert for that new data. For example, when a user accesses their personal web page, an alert for new events (for groups that the user is a member of) may be provided. Alerts may also be provided for news, blogs, and other information.

The exemplary accounting engine 312 is configured to maintain accounting and billing information for each organization 106. In various embodiments, each organization 106 via the home group 108 subscribes to a particular level of service with the social network host 102. The level of service may determine a certain number of megabytes of storage and bandwidth on the network 104 and types of features available to the groups of the organization 106, for example.

The storage 314 is configured to store various databases associated with the organizations 106, home groups 108, child groups 202-206, and individuals. In exemplary embodiments, the storage 314 comprises a relationship database 316, a profile database 318, a roles database 320, a web parts database 322, and a criteria database 324. These databases 316-324 are exemplary and alternative embodiments may comprise more or less databases or combine some of the databases 316-324 together. For example, other databases may provide layouts and themes, or store events, news, and blogs.

The exemplary relationship database 316 comprises tables storing relationships between the various organizations 106, groups, and individuals within the network 104. Such relationships may include, but are not limited to, parent-child relationships, sponsor-organization relationships, partner-organization relationships, and advertise-organization relationships.

The exemplary profile database 318 stores profile information for each organization 106, group 108 and 202-206, and individuals. Profile information may comprise name, contact information, security settings, preferences, attributes, and so forth. For each organization 106 (e.g., home group 108) and group, a general profile may be established. In some embodiments, the general profile will comprise default settings including default security settings that will apply to various web part components or data provided by the organization 106 and groups. For example, the security setting may only provide group data to members that are logged in. Similarly, each individual may establish a customized profile having settings including security settings.

The roles database 320 may, in some embodiments, store an individual's roles (e.g., responsibilities and permissions within a group). These roles may, in one embodiment, be based on relationships between individuals and the home group 108 and/or child groups 202-206. These relationships may, for example, identify the individual as a manager or leader of the group 108 or 202-206 (e.g., power over functions performed within the group and has access to all information handled by the group), officer or member (e.g., has limited powers to perform functions and access information as defined by the group manager), and administrator (e.g., responsible for technical and administrative maintenance of the group). As a result, the role of the individual determines access and functionalities enabled for the individual within the group and/or organization 106.

In exemplary embodiments, the web parts database 322 comprises components that are provided to customize a web page. Icons representing these web parts may be shown, for example on a pop-up window or on a side of the web page. The individual (e.g., group leader) may be drag and drop an appropriate icon onto a location of the web page where the selected component should appear in order to customize the web page. In some embodiments, the web parts components also enable functions on the web pages.

For example, when a child group 202-206 is activated on the network 104, the web page for the child group 202-206 may be preloaded with a default set of web parts. A leader of the child group 202-206 may change the web page by, for example, accessing the web parts database 322 and dragging and dropping icons representing components such as an event component (e.g., enables events to be posted on a calendar), news component (e.g., allows news to be posted on the page), media components (e.g., allow media, photos, etc. to be posted), and so forth. These web parts components also allow a leader or administrator to define how information is propagated up, alerts are set, and notifications sent. Once web parts components are dropped on the web page(s), then, according to some embodiments, information may be provided or uploaded to fill in blank templates generated by the web part components.

In some embodiments, the dragged and dropped web parts components may be customized to select which of the groups underneath the present group (e.g., a group's child groups) may be featured on the group's site. This results in propagation up of events, news, or other information from the child groups to the present group. For example, if a new event is posted in child group 1a 204a, this new event information may propagate up to a web page of group 1 202a.

Each web part component may allow the individual to select or set a security setting. In some embodiments, a default security setting is associated with the web part component, which may be altered by the individual administering the web page. For example, an events web part component for a group may have a default security setting that only members of the group may view the events and only leaders of the group may administer (e.g., update) the events web part component. The individual may then change the security setting to allow, for example, non-members (e.g., public) to view the events as well.

The criteria database 324 stores one or more predetermined set of criteria for establishing a relationship within the organization 106. In some embodiments, a different set of criteria may be established for each level of the organization 106. For example in an educational embodiment of the present invention, a predetermined set of criteria for establishing a department group (e.g., engineering department) may be different from a predetermine set of criteria for establishing an extra-curricular organizational group (e.g., student club or association).

Referring now to FIG. 4, the accounts engine 302 is shown in more details. The accounts engine 302 is configured to manage groups on the network 104 by setting up and maintaining data for each account (e.g., individual, group, and organization 106) on the network 104. The accounts engine 302 may comprise an account set-up module 402, an authentication module 404, a criteria generation module 406, a criteria match module 408, a group activation module 410, and a page customization module 412.

The exemplary account set-up module 402 is configured to provide a graphic interface which is utilized to establish an account with the network 104. The account may be for an individual, a group, or a home group 108. In exemplary embodiments, the graphical interface provides a plurality of fields where an individual or group creator enters information including profile and relationship information. With regards to a home group account, billing and service plan information for the organization 106 is also received by the account set-up module. With respect to establishing a child group account, the account set-up module 402 provides the interface to collect data that will be compared to the predetermined set of criteria.

The authentication module 404 authenticates individuals accessing the network 104. In some embodiments, the authentication module 404 will verify user names and passwords of individuals accessing web pages of the organization 106 and/or groups 202-206 by comparing an entered user name and password with one stored in the profile database 318.

The exemplary criteria generation module 406 provides an interface through which an authorized individual (e.g., home group leader or administrator) establishes one or more sets of criteria for creating a child group within the organization 106. The sets of criteria comprise a series of rules which may need to be met in order to automatically establish a new group. The sets of criteria are then stored in the criteria database 324.

The criteria match module 408 is configured to determine if data received from a user desiring to create a child group matches all of the conditions in the applicable predetermined set of criteria. In exemplary embodiments, the data is received from the account set-up module 402 and the applicable predetermined set of criteria is retrieved from the criteria database 324. The criteria match module 408 then performs an analysis to determine if the child group can be created.

In some embodiments, the creation of the child group automatically activates the child group within the organization 106. That is, if all the conditions set forth in the predetermined set of criteria is satisfied, the child group is activated by the group activation module 410. Once activated, the child group may establish a web page.

In other embodiments, one or more relationships of the child group 204a within the organization 106 may be inactive until corresponding groups within the organization 106 approve of a relationship request from the child group 204a. For example, second level group 1a 204a may be created by a member which wants to establish a relationship or link with group 1 202a being a parent to the new group 204a. While the child group 204a meets all of the conditions of the predetermined set of criteria established by the home group leader/administrator and is activated with respect to the home group 108, the relationship with the parent group 202a requires a group parent request handshake to be performed. This handshake comprises sending a group parent request message to an authorized individual (e.g., group leader) for group 1 202a for activation of the relationship.

Alternatively, a leader of the parent group 202a may have established the predetermined set of criteria for their child groups. In this case, the child group 204 a meets all of the conditions of the predetermined set of criteria established by the parent group leader/administrator and the relationship with respect to the parent group 202a is activated. In some embodiments, the web resource of the parent group 202a is shared with the new child group 204a until the home group approves separate web resources for the child group 204a. Thus, a handshake may be performed with the home group 108 leader which will activate the resources for the child group 204a. This activation process insures that the home group 108, which is paying for the social network service provided by the social network host 102, has control over use of resources subscribed to by the organization 106. As such, the group activation module 410 is configured to process the activation process.

In exemplary embodiments, the group activation module 406 will initiate these activation processes by triggering the messaging engine 304 to perform a message-based handshake between the new child group 202a (e.g., the creator of the new child group 202a) and the authorized individual associated with the group that needs to approve activation of a relationship or resource. The handshake process will be discussed in more detail in connection with FIG. 5. Once approval is granted, the creator and/or leader of the child group 202a may be notified.

The exemplary page customization module 412 is configured to allow the creator or leader of the child group 202a to customize the group's web page. In exemplary embodiments, a default web page is initially associated with the group. Web parts components may, in some embodiments, be used to customize the web page, as described above. The page customization module 408 provides access to these web parts components in the web parts database 322. In some embodiments, these web parts components may have default security settings, which the user may customize.

Referring to now to FIG. 5, the exemplary messaging engine 304 is shown. The messaging engine 304 is configured to enable communications within and between organizations 106. In various embodiments, the messaging engine 304 provides communications (e.g., e-mails) between the groups and individuals within the organization 106. These communications may include messages-based handshakes. Handshakes comprise message exchanges and may be used, in some embodiments, to approve relationships between groups and individuals and/or request further information in order to create groups and relationships.

In some embodiments, not all conditions of the predetermined set of criteria may be met. If the non-met condition(s) is not vital or critical, then a request for further information or a request to change the child group in order to met the condition may be sent. The messaging engine 304 provides the mechanism to exchange messages between the requestor for the new child group and an authorized individual associated with the predetermined set of criteria.

The messaging engine 304 may comprise a messaging interface 502 and a handshake module 504. Alternative embodiments may comprise other modules. The exemplary messaging interface 502 is configured to provide a graphical interface through which a handshake mechanism (e.g., an e-mail) may be composed and sent. In various embodiments, the messaging interface 502 may display a template for a particular handshake type. The template may comprise fields in which the user provides information or request information. In other embodiments, the template may comprise default fields which the user may change before sending.

In some embodiments, the type of handshake or template provided may be automatically determined by the handshake module 504. For example, if a condition is not provided and cannot be compared with the predetermined set of criteria, then the handshake module 504 may automatically generate a request for further information to be sent to the child group creator.

In other embodiments, the user may select the handshake type or template. For example, a drop down menu or listing of handshakes types on a side of a web page may be presented to the user by the handshake module 504. The user may then select one of the handshake types and use the default template, customize the template, and/or fill in fields on the template. For example, if conditions are not met, the child group creator may select a handshake type that allows the creator to request suggestions for meeting the predetermined set of criteria.

The handshake module 504 provides the message to a recipient. In some embodiments, the handshake module 504 may also generate a response template for the recipient to return. The response template will be based on the original message and provide fields and/or customization features. For example, if a home group leader receives a message requesting suggestions for meeting the predetermined set of criteria, a response template may be provided that provides a list of suggestions from which the recipient can select (e.g., check a box) the appropriate suggestions.

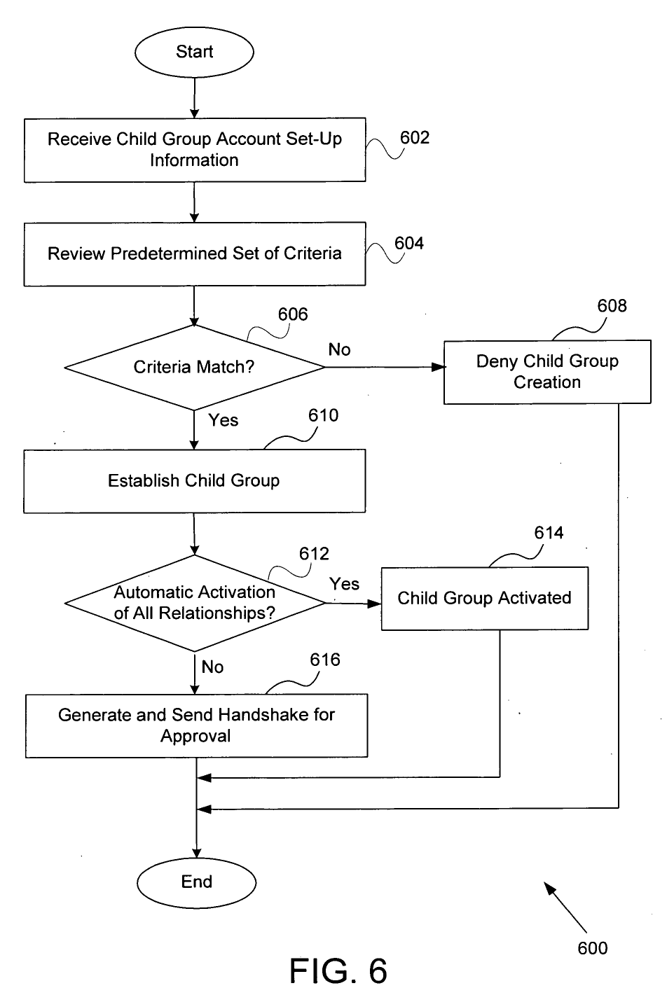

Referring now to FIG. 6, an flowchart 600 of an exemplary method for establishing a child group within an organization on the group-centric network is provided. According to one embodiment, a user associated with the organization 106 may attempt to create a new child group within the organization 106. The user may access the account set-up module 402 and provide child group account information. The account information comprises terms/conditions for the child group. Such terms may include, for example, group leader identity, desired parent and home group relationship(s), purpose of the group, and targeted member types. The terms may be provided by various mechanisms including entry into a field, selection from a list of choices, etc. This group account information is received by the accounts engine in step 602.

Next, a predetermined set of criteria is reviewed in step 604. In exemplary embodiments, the criteria match module 408 retrieves the applicable predetermine set of criteria from the criteria database 324. The retrieved set of criteria is then compared to the account information in step 606 to determine if all the criteria are met. If the criteria are not met, then the creation of the child group is denied in step 608.

If, however, all the criteria are met, then the child group is established in step 610. In some embodiments, the child group can establish their presence on the network 104, and may be provided a default web page which may be customized. The child group is also allowed to start accepting (or sending invitations to attract) members.

While the child group has been established and a corresponding web presence allowed, not all relationships requested by the child group may be activated. Thus, in step 612, a determination is made as to whether automatic activation of all relationships is performed. The creation, of some child groups may allow automatic activation of all requested relationships based solely on satisfying the predetermined set of criteria. In these embodiments, the child group is fully activated in step 614.

In alternative embodiments, some relationships may not be automatically activated. For example, a relationship with the home group 108 may automatically be activated, however, a relationship with a direct parent group (e.g., group 1 202a) may not be automatically activated without notice and acknowledgement of the parent group leader. In these embodiments a handshake is generated and sent in step 616. The handshake may comprise a message requesting approval of the relationship. Once approved, the relationship is activated and the child group may become fully functional within the group-centric network.

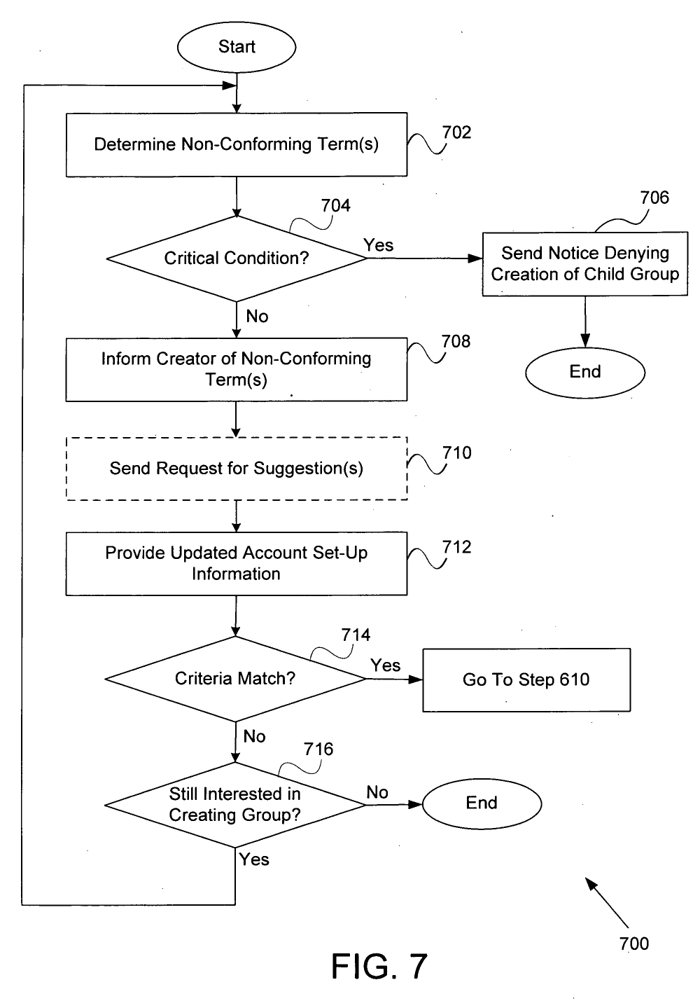

FIG. 7 is a flowchart 700 of an exemplary method for attempting to establish a child group after an initial denial. If the terms/conditions provided by the user do not completely match the predetermined set of criteria established for the organization 106, the accounts engine 302 may allow communications to be exchanged and modifications to the terms made in order to meet the predetermined set of criteria. In step 702, the criteria match module 408 determines the one or more non-conforming terms. If the non-conforming term(s) are determined to be critical in step 704, the user is notified of the denial of the child group creation in step 706.

If the non-conforming conditions are not critical, then the user may be given another change to meet the criteria. A condition may be considered not critical if, for example, the user that established the criteria indicates that the particular criteria term is of low priority. In step 708, the creator is informed of the non-conforming term(s).

In optional step 710, the creator may send a message requesting suggestions (e.g., suggestion handshake) in order to meet the non-conforming term. An associated group leader or administrator will received the message request and may provide suggestions.

The creator may then provide updated account information including the corrected terms in step 712. A criteria match process is then performed in step 714 to determine if the updated account information not satisfies the predetermined set of criteria. If the criteria are satisfied, then the process may return to step 610 of FIG. 6. If, the criteria are still not satisfied, then assuming that the creator is still interested in creating the child group in step 716, the process will return to step 702.

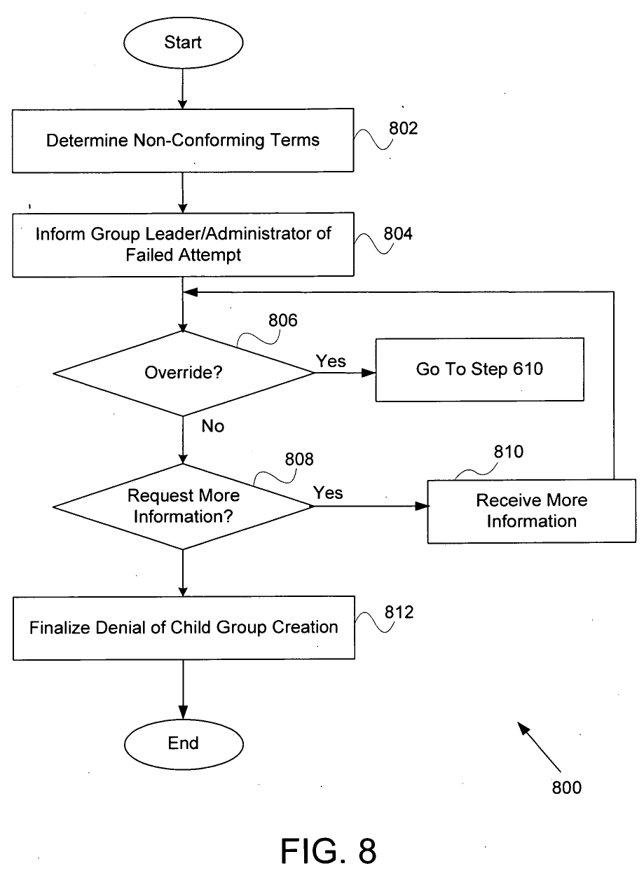

Referring now to FIG. 8, a flowchart 800 of an exemplary method for creating a child group involving an override is shown. Assuming that not all terms of the predetermined set of criteria has been met, a preliminary denial of the creation of the child group may occur. However, an authorized individual of the organization 106 may have an ability to override the denial.

In step 802, the criteria match module 408 determines the one or more non-conforming terms which resulted in the preliminary denial. The authorized individual (e.g., a group leader or administrator) is notified of the failed attempted in step 804. In exemplary embodiments, an override handshake may be performed whereby a message is sent via the messaging engine 304. In exemplary embodiments, the handshake module 504 may provide a template that lists the non-conforming term and provide selections for further action. The selections may comprise a denial of the override, acceptance of the override, and/or a request for further information from the creator.

In step 806, the authorized individual may decide to override the preliminary denial. If the authorized individual decides to override the preliminary denial (e.g., selecting a box next to an entry for accepting the override), then a return message of the override handshake will indicate the override. The process then returns to step 610 in FIG. 6.

If the authorized individual does not select to override, then a determination is made as to whether the authorized individual is requesting more information from the creator in step 808. For example, the authorized individual may select the request more information selection. In this case, a information request handshake is performed whereby a message is generated and sent to the creator requesting further information. The further information will be received in a return message in step 810. Based on the contents of the returned message, the authorized individual may decide whether to override or request more information.

If the authorized individual does not override or request more information, then the preliminary denial is finalized in step 812.

For example, the non-conforming term may be that the user requesting the creation of the new child group is not authorized to do so. In this case, the home group or parent group leader may be sent a message that informs them non-conforming term (i.e., creation by a non-authorized user). The group leader may override the predetermined criteria and allow the creation of the child group.

The above-described functions and components can be comprised of instructions that are stored on a storage medium. The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with embodiments of the present invention. Those skilled in the art are familiar with instructions, processor(s), and storage medium.

The present invention has been described above with reference to exemplary embodiments. It will be apparent to those skilled in the art that various modifications may be made and other embodiments can be used without departing from the broader scope of the invention. For example, the group may comprise a single individual user. In further embodiments, principals of the present invention may be applied to creation of relationships between organizations or groups within different organizations. Therefore, these and other variations upon the exemplary embodiments are intended to be covered by the present invention.

What is claimed is:

1. A method for creating organizational hierarchies in an organization of a group-centric network, comprising:
receiving a request from a user to establish a new group within the organization on the group-centric network, the request comprising account information including a plurality of terms;
retrieving an applicable, predetermined set of criteria for group creation;
determining if the plurality of terms in the request match the predetermined set of criteria; and
if there is a match, creating the new group and activating at least one relationship of the new group.

2. The method of claim 1 further comprising denying the creation of the new group if there is no match.

3. The method of claim 1 further comprising determining one or more non-conforming terms if there is no match.

4. The method of claim 3 further comprising determining if the one or more non-conforming terms are critical.

5. The method of claim 3 further comprising informing an authorized individual of a failed creation attempt via a message.

6. The method of claim 5 wherein the message further comprises a listing of the one or more non-conforming terms.

7. The method of claim 1 further comprising receiving an override from an authorized individual to create and activate the new group if there is no match.

8. The method of claim 1 further comprising facilitating a message based handshake between the user and an authorized individual.

9. The method of claim 8 wherein the message based handshake comprises a request for further information.

10. The method of claim 8 wherein the message based handshake comprises a request for suggestions in order to conform with the predetermined set of criteria.

11. The method of claim 8 wherein the message-based handshake comprises a request for activation of one or more non-activated relationships.

12. The method of claim 1 further comprising allowing the user to revise the terms of the account information if there is no match.

13. The method of claim 1 further comprising establishing one or more predetermined sets of criteria for new group creation.

14. The method of claim 1 wherein the new group is an individual user.

15. A system for creating organizational hierarchies in an organization of a group-centric network, comprising:
an account set-up module configured to receive account information for establishing a new group within the organization on the group-centric network;
a criteria database configured to store one or more predetermined set of criteria for group creation; and
a criteria match module configured to retrieve an appropriate, predetermined set of criteria for group creation and compare the received account information to the retrieved, predetermined set of criteria.

16. The system of claim 15 further comprising a group application module configured to activate one or more relationships of the new group.

17. The system of claim 15 further comprising a messaging engine configured to perform at least one message-based handshake.

18. The system of claim 15 further comprising a criteria generation module configured to allow an authorized individual to create the predetermined set of criteria for group creation.

19. A machine readable medium having embodied thereon a program, the program having instructions operable by a machine for creating organizational hierarchies in an organization of a group-centric network, the method comprising:
receiving a request from a user to establish a new group within the organization on the group-centric network, the request comprising account information including a plurality of terms;
retrieving an applicable, predetermined set of criteria for group creation;
determining if the plurality of terms in the request match the predetermined set of criteria; and
if there is a match, creating the new group and activating at least one relationship of the new group.

20. The machine readable medium of 19 wherein the method further comprises establishing one or more predetermined sets of criteria for new group creation.
